(19) United States
(12) Patent Application Publication
(10) Pub. No.: US 2009/0154537 A1
(43) Pub. Date: Jun. 18, 2009

(54) Frequency Selection Cable Reflector

(75) Inventors: Paul Gothard Knutson, Lawrenceville, NJ (US); Max Ward Muterspaugh, Indianapolis, IN (US); Kumar Ramaswamy, Princeton, NJ (US)

Correspondence Address: Thomson Licensing LLC, P.O. Box 5312, Two Independence Way, PRINCETON, NJ, 08543-5312, US

(73) Assignee: Thomson Licensing LLC

(21) Appl. No.: 12/083,281

(22) PCT Filed: May 31, 2006
(86) PCT No.: PCT/US2006/020729

§ 371 Date: Apr. 8, 2008

Related U.S. Application Data
(60) Provisional application No. 60/725,798, filed on Oct. 12, 2005.

(51) Int. Cl. H04B 1/38

(52) U.S. Cl. 375/222

(57) ABSTRACT

An apparatus for use in a cable system comprises a first port for use in coupling to a portion of a cable network for receiving an upstream signal having a frequency spectrum including a first frequency band; and a reflector for reflecting the received upstream signal back downstream via the first port; wherein the first frequency band is different from those frequency bands used by a head-end of the cable network for Internet communications.

### BACKGROUND OF THE INVENTION

The present invention generally relates to communications systems and, more particularly, to cable television systems.

Current cable television (TV) systems offer a number of services to customers such as TV programming (both network and local), pay-per-view programming and Internet access. One example of a cable TV system is a hybrid fiber/coax based network that has a bandwidth capacity of 750 MHz (millions of hertz), or more, for delivering these services to their subscribers. This bandwidth capacity is typically divided between a down stream channel and an upstream channel. The downstream channel conveys not only the TV programming but also the downstream Internet data communications to each subscriber; while the upstream channel conveys the upstream Internet data communications from each subscriber.

### SUMMARY OF THE INVENTION

The above described distribution of cable TV bandwidth into a downstream channel and an upstream channel does not efficiently support peer-to-peer communications since any data communicated between endpoints must pass through the cable head-end. Therefore, and in accordance with the principles of the invention, an apparatus for use in a system comprises a first port for use in coupling to a portion of a network for receiving an upstream signal having a frequency spectrum including a first frequency band; and a reflector for reflecting the received upstream signal back downstream via the first port; wherein the first frequency band is different from those frequency bands used by a controller of the network for bidirectional communications.

In an illustrative embodiment of the invention, a device for use in a network is a reflector. Illustratively, the network is a cable network and the controller is a head-end of the cable network. The reflector comprises a bandpass filter for filtering the received upstream signal to provide an output signal for downstream transmission, wherein a frequency spectrum of the output signal includes a first frequency band; wherein the first frequency band is different from those frequency bands used by a head-end of the cable network for bi-directional communications (e.g., Internet communications).

In another illustrative embodiment of the invention, the reflector comprises a band stop filter for reflecting the received upstream signal back downstream.

In another illustrative embodiment of the invention, a device for use in a network is a cable modem comprising a port for use in coupling to a cable system; and at least one modem coupled to the port for (a) communicating to a two-way network over a first pair of frequency bands and (b) communicating to at least one other endpoint of the cable system over another frequency band different from the first pair.

### BRIEF DESCRIPTION OF THE DRAWINGS

FIG. 1 shows an illustrative cable system in accordance with the principles of the invention;

FIG. 2 shows an illustrative frequency spectrum in accordance with the principles of the invention;

FIGS. 3-5 show illustrative embodiments of a reflector device in accordance with the principles of the invention;

FIG. 6 shows another illustrative cable system in accordance with the principles of the invention;

FIG. 7 shows another illustrative embodiment of a reflector device in accordance with the principles of the invention;

FIG. 8 shows another illustrative cable system in accordance with the principles of the invention;

FIGS. 9 and 10 show other illustrative embodiments of a reflector device in accordance with the principles of the invention;

FIG. 11 illustrates peer-to-peer communications in accordance with the principles of the invention; and

FIG. 12 shows an illustrative embodiment of a cable modem in accordance with the principles of the invention.

### DETAILED DESCRIPTION

Other than the inventive concept, the elements shown in the figures are well known and will not be described in detail. Also, familiarity with television broadcasting and receivers in the context of terrestrial, satellite and cable is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) ATSC (Advanced Television Systems Committee) (ATSC) and ITU-T J.83 “Digital multi-programme systems for television, sound and data services for cable distribution” is assumed. Likewise, other than the inventive concept, familiarity with satellite transponders, cable head-ends, set-top boxes, downlink signals and transmission concepts such as eight-level vestigial sideband (8-VSB), Quadrature Amplitude Modulation (QAM), out-of-band control channels and receiver components such as a radio-frequency (RF) front-end, or receiver section, such as a low noise block, tuners, and demodulators is assumed. Similarly, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements. Also, as used herein, the term “endpoint” includes, but is not limited to, stations, personal computers, servers, set-top boxes, cable modems, etc.

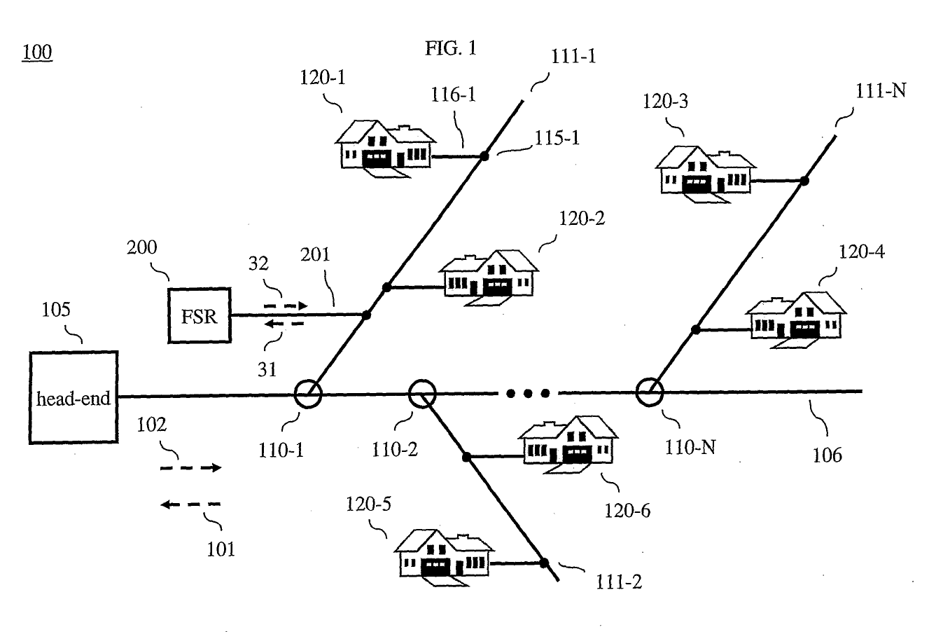

Turning now to FIG. 1, an illustrative cable system 100 in accordance with the principles of the invention is shown. Illustratively, cable system 100 is a hybrid-fiber coax (HFC) system. For simplicity, the fiber portion is not described herein. It should be noted that although the inventive concept is described in the context of coaxial cable (coax), the inventive concept is not so limited and can be extended to the processing of fiber optic signals. A plurality of stations, as represented by stations 120-1 to 120-6, are connected to a common head-end 105 by a tree and branch cable network. In the context of the inventive concept, a head-end is an example of a controller for a network. Each station is associated with a cable subscriber. Each station includes, e.g., a set top box for receiving video programming and a cable modem for bidirectional data communications to a two-way network, e.g., the Internet. Head-end 105 is a stored-program-processor based system and includes at least one processor (e.g., a microprocessor) with associated memory, along with a transmitter and receiver coupled to the cable network (for simplicity, theses elements are not shown). Ignoring for the moment element 200, the cable network comprises a main coaxial cable 106 having a plurality of taps 110-1, 110-2 to 110-N. Each of these taps serves a corresponding feeder cable. For example, tap 110-1 serves feeder cable 111-1. Each feeder cable in turn serves one, or more, stations via a tap and a drop. For example, feeder cable 111-1 serves station 120-1 via tap 115-1 and drop 116-1. For the purposes of this description, it is assumed that the devices of cable network 100, e.g., taps, drops, etc., are addressable and controllable by head-end 105 via an out-of-band signaling channel (not shown in FIG. 1). Other than the inventive concept, the use of an out-of-band signaling channel to address and control devices in particular portions of the cable network is known. For example, an out-of-band control channel that is a frequency shift keying (FSK) based can be used for both addressing and control of devices in a cable network. One such system is the Addressable Multi-Tap Control System available from Blonder Tongue Laboratories, Inc.

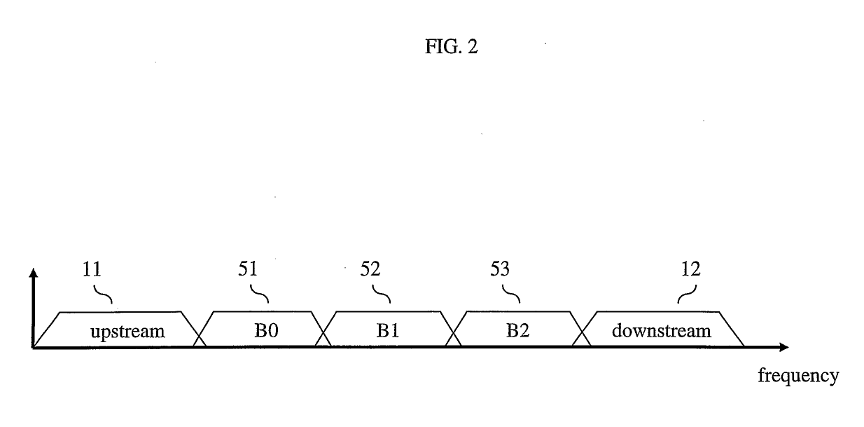

In cable system 100, communications between head-end 105 and the various stations occurs in both an upstream direction and a downstream direction. The upstream direction is towards head-end 105 as represented by the direction of arrow 101 and the downstream direction is towards the stations as represented by the direction of arrow 102. In accordance with the principles of the invention, cable system 100 includes a device that enables peer-to-peer communications between endpoints of cable system 100 without having to pass through the head-end 105. This is further illustrated in FIG. 1 by frequency selective reflector (FSR) device 200, which is illustratively located at the beginning of feeder cable 111-1. However, the inventive concept is not so limited and a device including the reflector function can be located in any portion of the cable network. Turning for the moment to FIG. 2, in accordance with the principles of the invention a number of communication bands are added to the existing cable frequency spectrum. Typically, a cable system provides services via an upstream band 11 and a downstream band 12. These services include Internet communications and television programming. However, in order to enable peer-to-peer communications, additional bands are now added. These peer-to-peer frequency bands are different from those used by the cable system for Internet communications. Illustratively, FIG. 2 illustrates three peer-to-peer bands located between upstream band 11 and downstream band 12. However, the inventive concept is not so limited and more, or less, bands may be used and their placement in the spectrum may vary. It should also be noted that FIG. 2 is not to scale and that transition regions between bands may be required. As shown in FIG. 2, the three peer-to-peer bands are: B0, B1 and B2.

Returning to FIG. 1, FSR device 200 receives a communication from an endpoint located off of feeder cable 111-1 (e.g., station 120-1) via an upstream peer-to-peer band as represented by dashed arrow 31 (e.g., B0 of FIG. 2). FSR device 200 reflects the upstream signal in this peer-to-peer band (e.g., B0 of FIG. 2) back downstream to other users located off of feeder cable 111-1 as represented by dashed arrow 32.

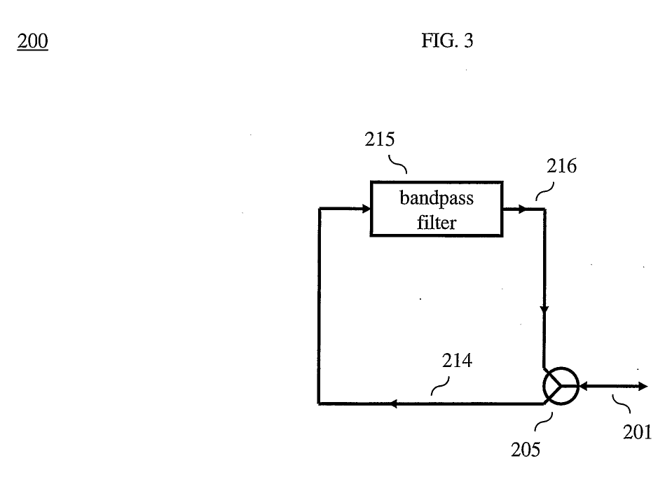

Turning now to FIG. 3, an illustrative embodiment of FSR device 200 is shown. FSR device 200 comprises directional coupler 205 and bandpass filter 215. An upstream signal from drop 201 is received via directional coupler 205, which is provided to bandpass filter 215. Bandpass filter 215 has one, or more, pass bands that correspond to the upstream peer-to-peer bands shown in FIG. 2. In other words, bandpass filter 215 blocks signals outside of these frequency ranges (such as any frequency components of upstream band 11 and downstream band 12). The output signal 216 is coupled back to drop 201, via directional coupler 205, for transmission back downstream for receipt by, e.g., station 120-2. Thus, FSR device 200 appears as a reflector for the frequencies in the pass band of filter 215. It should be noted that FSR device 200 may be configurable to translate a particular one, or more, of the peer-to-peer bands of the cable network. For example, FSR device 200 may be configured to only use peer-to-peer band B0 of FIG. 2. This configuration is preferably performed via the above-mentioned out-of-band control channel (not shown in FIG. 3).

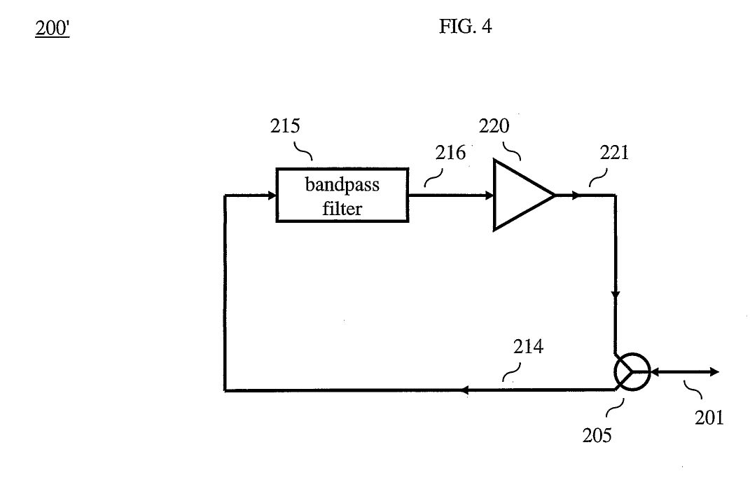

Turning now to FIG. 4, another illustrative embodiment of an FSR device 200 is shown. This device is labeled as 200′. FSR device 200′ is similar to the FSR device of FIG. 3 except for the addition of amplifier 220. The later is provided if necessary to correct the gain due to losses in the filters, and to match the transmitted signal to the amplitude of the other channels in the cable system. Amplifier 220 provides downstream signal 221, which is coupled back to drop 201, via directional coupler 205, for transmission back downstream for receipt by, e.g., station 120-2.

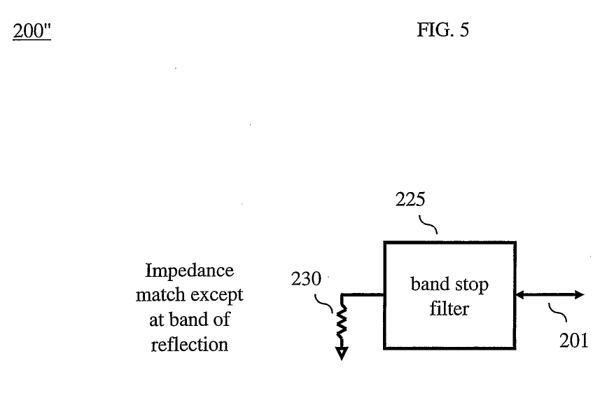

Moving forward to FIG. 5, another illustrative embodiment of an FSR device 200 is shown. This device is labeled as 200″. FSR device 200″ represents an illustrative passive reflector using an impedance control technique. FSR device 200″ includes a band stop filter 225 and a resistor 230. In this example, FSR device 200″ is a circuit that matches the transmission line impedance at all frequencies but at the desired frequency of reflection (e.g., peer-to-peer band B0) FSR device 200″ looks like an open or a short. For example, a band stop filter (225) with a terminator (represented by resistor 230) at the output will cause a reflection over the band stop frequency range, since in the pass band the filter 225 matches the transmission line impedance, and in the stop band the filter 225 impedance mismatch causes a reflection.

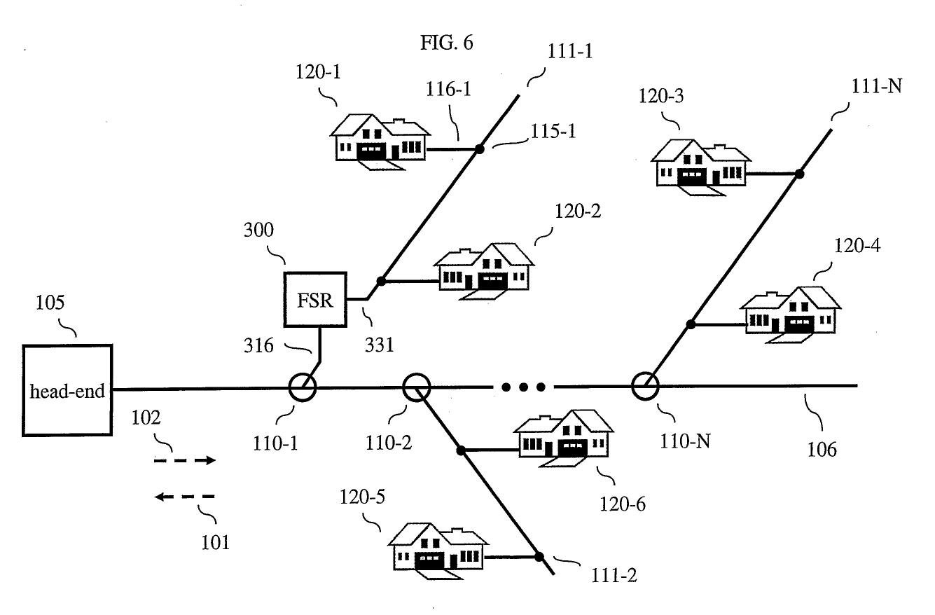

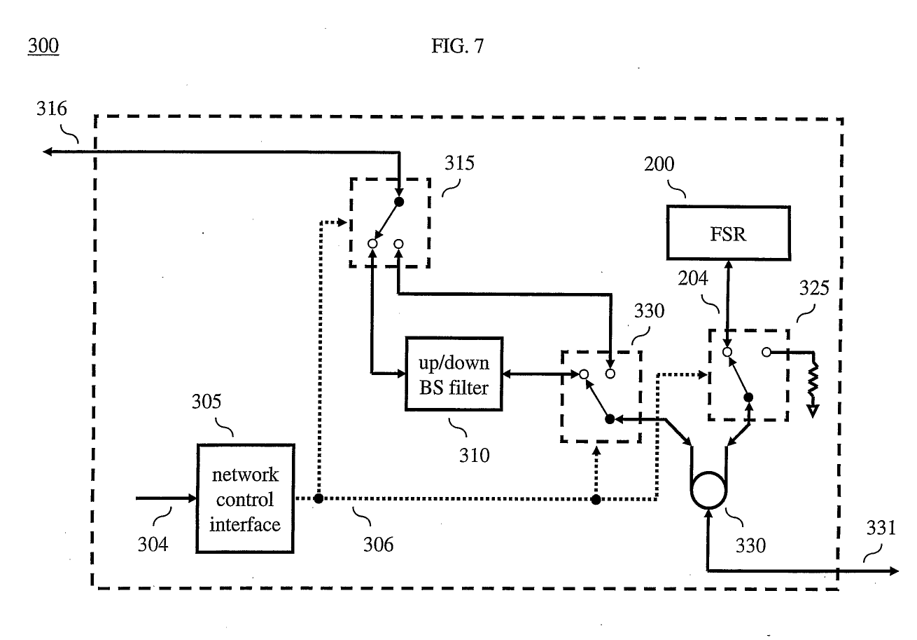

As noted above, a cable system may have one, or more, devices supporting a reflector function located in one, or more, portions of the cable network. Illustratively, FIG. 1 shows a reflector device coupled to a feeder cable. Another illustrative location and type of reflector device is shown in FIG. 6. The elements in FIG. 6 are similar to those found in FIG. 1 except for FSR device 300, which serves feeder cable 111-1. As can be observed, all upstream and downstream communications pass through FSR device 300. An illustrative embodiment of FSR device 300 is shown in FIG. 7.

FSR device 300 comprises switches 315, 320 and 325, up/down band stop (BS) filter 310, network control interface 305, splitter 330 and FSR device 200. The latter is identical to FSR device 200 of FIG. 3 (or FIGS. 4 and 5), except that directional coupler 205 of FIG. 3 is coupled to path 204 as shown in FIG. 7. Network control interface 305 allows a system control processor (not shown) in the cable network (e.g., located in head-end 105) the ability to configure the reflector, e.g., whether it is on or off, establish frequency (e.g., which peer-to-peer bands to use) and/or gain settings (if any). Illustratively, in this embodiment, network control interface 305 controls whether or not the reflector function is enabled for feeder cable 111-1. In particular, network control interface 305 is responsive to the above-mentioned out-of-band signaling channel (represented by signal 304) for enabling or disabling the reflector function in FSR device 300 via switches 315, 320 and 325, which are controlled by network control interface 305 via control signal 306 (shown in dotted-line form). In this regard, the out-of-band signaling channel is modified to include predefined commands that are associated with enabling or disabling the reflector function in a particular device. When the reflector function is disabled, switches 315 and 310 are configured such that all upstream signals received, via path 331, from feeder cable 111-1 are passed, via splitter 330, to main coaxial cable 106. Likewise, all downstream signals received, via path 316, from the main coaxial cable 106 are passed, via splitter 330, to feeder cable 111-1. In addition, switch 315 disconnects FSR device 200 from the network. However, when the reflector function is enabled, all upstream signals received, via path 331, from feeder cable 111-1 are also provided to FSR device 200, via switch 325. FSR device 200 functions as described above to reflect one, or more, peer-to-peer bands for transmission back down feeder cable 111-1. Further, when the reflector is enabled, up/down BS filter 310 is now switched in to further filter both upstream and downstream communications. BS filter 310 has stop bands that correspond to the peer-to-peer bands used by FSR device 200 and any other FSR devices located further downstream of path 331. For example, if FSR device 200 is configured to only use peer-to-peer band B0 of FIG. 2, up/down BS filter 310 has a stop band corresponding to peer-to-peer band B0 to prevent any interference with the peer-to-peer transmission using band B0 on feeder cable 111-1.

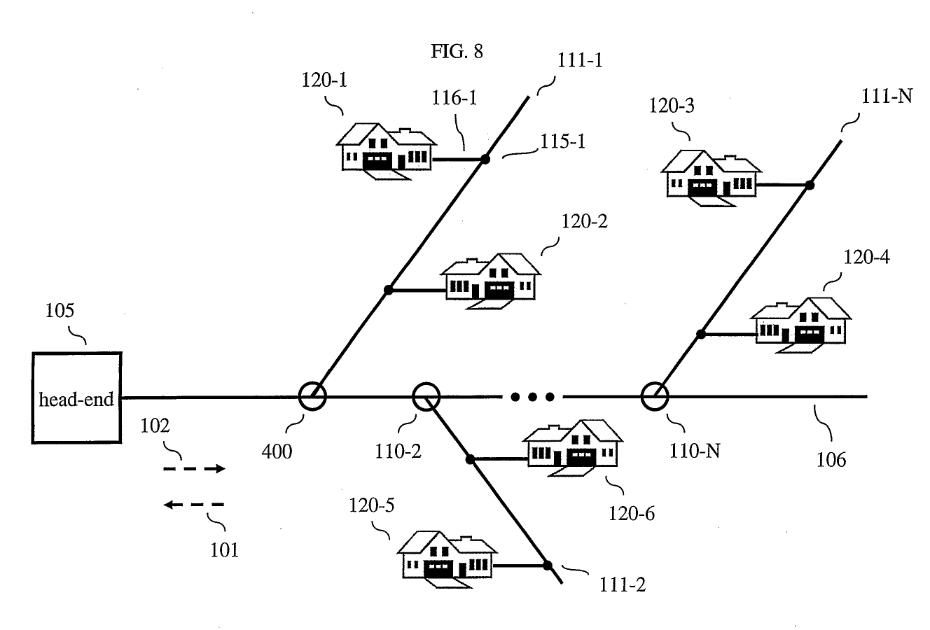

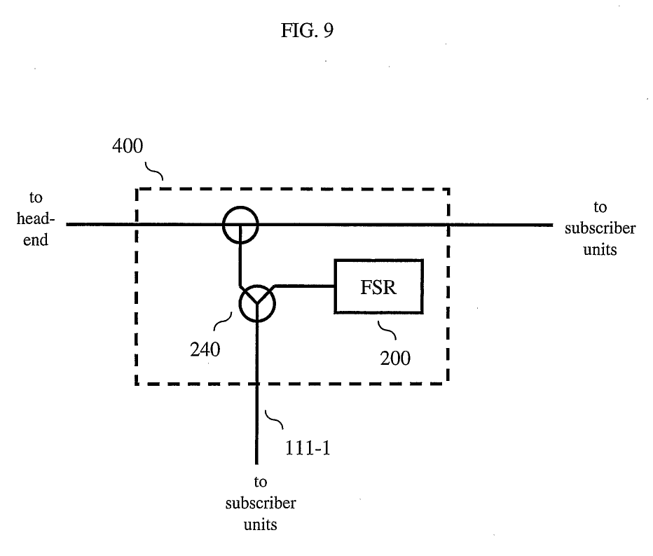

Another illustrative embodiment of a cable system in accordance with the principles of the invention is shown in FIG. 8. This figure is similar to FIG. 6 except for tap 400, which includes the reflector function. Tap 400 is shown in more detail in FIG. 9. As can be observed from FIG. 9, tap 400 comprises FSR device 200 of FIG. 3 (or FIGS. 4 and 5) coupled to feeder cable 111-1 via directional coupler 240. Thus, and in accordance with the principles of the invention, tap 400 is used to provide a reflector function in the cable system.

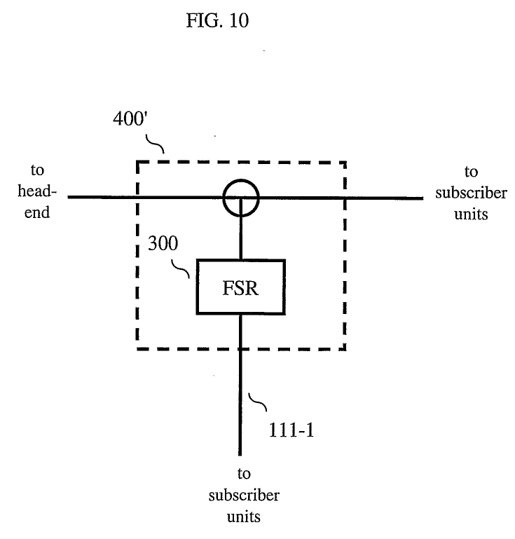

Another illustrative embodiment of a tap 400 in accordance with the principles of the invention is shown in FIG. 10. This device is labeled as 400′. As can be observed from FIG. 10, tap 400′ comprises FSR device 300 of FIG. 7 (described above).

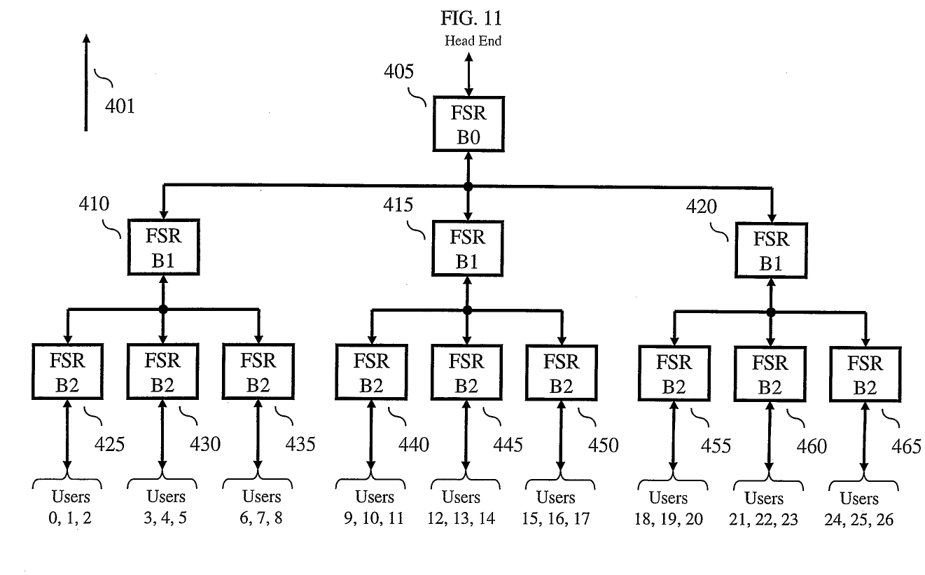

As described above, the reflector function is deployed in the cable network to provide local area peer-to-peer connectivity. FIG. 11 shows an illustrative application of the inventive concept to a cable network in the context of a number of reflector devices. As indicated earlier, one, or more, of these reflector devices may actually be incorporated in other devices of the cables network, such as taps, etc. In this example, it is assumed that there are three peer-to-peer bands as shown in FIG. 2. Each of the peer-to-peer bands is associated with a particular portion of the cable network. In this example, the cable network is mapped to a communication hierarchy having a number of levels. The top level is represented by FSR device 405; the next level is represented by FSR devices 410, 415 and 420; and the last level is represented by FSR devices 425, 430 435, 440, 445, 450, 455, 460 and 465. Each level is indicative of a relative placement in the cable network and is also representative of a level of connectivity. In FIG. 11, the upstream direction is indicated by arrow 401. As such, the top level (FSR device 405) is located further upstream (closer to the cable head-end). An illustrative location for FSR device 405 is near the optical/electronic (O/E) interface of the cable network. The next level (FSR devices 410, 415 and 420) are located further downstream, e.g., in each of the taps that serve a particular feeder cable (or branch) of the cable network. The last level (FSR devices 425 through 465) are located even further downstream, e.g., in each of the taps that serve a particular drop of the cable network. The top level reflects peer-to-peer band B0; the next level reflects peer-to-peer band B1 and the last level reflects peer-to-peer band B2. It is assumed for the purposes of this example that each FSR device blocks upstream transmission of its assigned peer-to-peer band (using, e.g., a band stop filter as illustrated by BS filter 310 of FIG. 7) but passes communications in any of the other peer-to-peer bands in either direction.

Thus, and in accordance with the principles of the invention, a User 0 located on a cable drop served by FSR device 425 can communicate to similarly situated users—User 1 and User 2—by using peer-to-peer band B2. Similarly, if User 0 desires to communicate with User 6, User 0 can use peer-to-peer band B1. Finally, if User 0 desires to communicate with User 17, User 0 can use peer-to-peer band B0. It can be observed from FIG. 8 that the layer supported by peer-to-peer band 2 is reused 9 times, allowing local servers or caches to provide data to local users 9 times more efficiently than communication direct from the head-end. Similarly, peer-to-peer band B1 on the next higher 1 layer is reused 3 times; while peer-to-peer band B0 is used only once. As noted earlier, one, or more, of these reflector devices can be configured and enabled/disabled via the out-of-band control channel.

As described above, the inventive concept allows for the deployment of peer-to-peer network operations in a cable plant. Illustratively, the cable plant reserves bands for peer-to-peer communications and one, or more, devices with a reflector function are placed in the network. This allows a signal source at the edge of the network to transmit a signal upstream to the reflector, which reflects the signal back downstream so that downstream users can receive the signal. As noted above, this device may be deployed at any portion of the cable network. It should be noted that insertion of a reflector higher up in the distribution tree will require that the gain nodes be capable of bidirectional amplification over the band of interest. This will require changes to all the taps and amplifiers downstream from the reflector, and it will require that the network be carefully terminated as to prevent reflective loops. As such, multiple levels of reflectors will require careful attention to the amplifier gain and phase characteristics in the system to insure stability. Ideally, an automatic gain control (AGC) function will be needed to keep the signal amplitudes uniform whether they come from the head end or a reflected set top box (STB) transmission. In view of this complexities, it may be preferable to confine use of a reflector device to one lower level, e.g., at a drop, or branch.

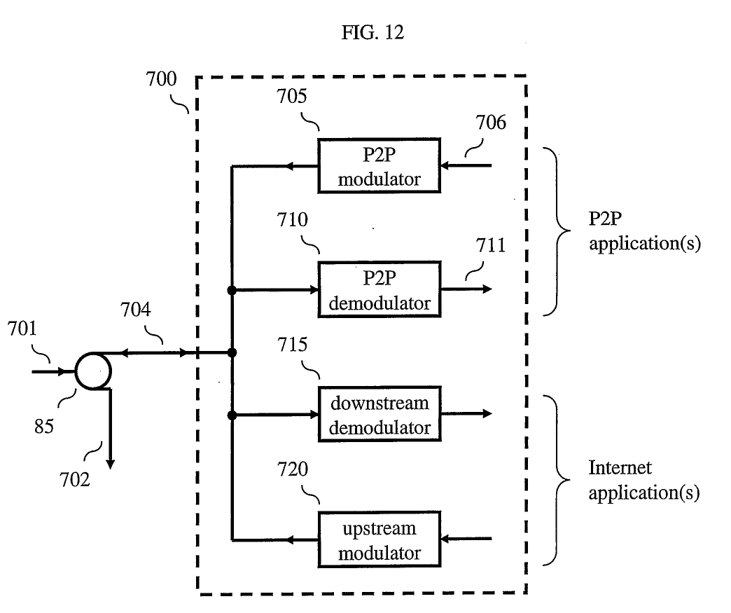

As described above, separate bands are used to provide peer-to-peer connectivity in a cable network. In this regard, and in accordance with the principles of the invention, the cable modem function, or device, located in a station is modified to permit peer-to-peer communication. An illustrative embodiment of such a cable modem is shown in FIG. 12. Cable modem 700 comprises a peer-to-peer (P2P) modulator 705, a P2P demodulator 710, a downstream demodulator 715 and an upstream modulator 720. Cable modem 700 is coupled to a cable network via a drop 701, a splitter 85 and path 704. The splitter 85 also provides a cable signal 702 to other equipment located at the station, e.g., a set top box (not shown). Upstream modulator 720 and downstream modulator 715 function as known in the art and enable a user to have Internet service and run Internet applications (e.g., a browser located on a personal computer (PC) (not shown). P2P modulator 705 and P2P demodulator 710 provide the above-mentioned peer-to-peer connectivity and are configurable to one, or more, of the peer-to-peer bands (e.g., as illustrated in FIG. 2): These settings may be determined via software as options set by the user via the PC coupled to cable modem 700. In addition, the PC may store address information for particular members of the peer-to-peer network, where each address is associated with a particular peer-to-peer band. Upstream peer-to-peer communications is provided via signal 706 to P2P modulator 705, which provides an upstream signal in the designated peer-to-peer band. Downstream peer-to-peer communications is provided via signal 711 from P2P demodulator 710, which demodulates received signal in the designated peer-to-peer band. It should be noted that cable modem 700, as known in the art, includes directional couplers (not shown) to provide signal isolation between the transmit and receive paths. As described herein, peer-to-peer communications includes not only messaging, but also, e.g., broadcast messages, multi-casting, etc. For example, a user can stream content from one endpoint to one or more other endpoints of the cable system in accordance with the principles of the invention. This content can be video, audio, etc. Further, although the inventive concept was described in the context of application to a traditional cable system, the inventive concept is not so limited and is applicable to any form of network, even, e.g., a home network, campus network, etc.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one or more integrated circuits (ICs). Similarly, although shown as separate elements, any or all of the elements may be implemented in a stored-program-controlled processor, e.g., a digital signal processor (DSP) or microprocessor that executes associated software. For example, the separate modulator and demodulator functions shown in FIG. 12 may be located in one, or more, DSPs. Further, although shown in particular configurations, the elements therein may be distributed in different units in any combination thereof. For example, a cable modem may be a part of a personal computer, a reflector may be located in a server of the cable network, etc. It is therefore to be understood that numerous modifications may be made to the illustrative embodiments and that other arrangements may be devised without departing from the spirit and scope of the present invention as defined by the appended claims.

1. Apparatus for use in a system, the apparatus comprising:
a first port for use in coupling to a portion of a network for receiving an upstream signal; and
a reflector for reflecting the received upstream signal back downstream via the first port.

2. The apparatus of claim 1, wherein the upstream signal has a frequency spectrum including a first frequency band that is different from those frequency bands used by a controller of the network for bidirectional communications.

3. The apparatus of claim 2, wherein the network is a cable network and the controller is a head-end of the cable network.

4. The apparatus of claim 2, wherein the reflector comprises:
a bandpass filter for filtering the received upstream signal to provide an output signal for downstream transmission, wherein a frequency spectrum of the output signal includes the first frequency band.

5. The apparatus of claim 4, further comprising:
an amplifier for amplifying the output signal for transmission downstream.

6. The apparatus of claim 1, wherein the reflector comprises:
a band stop filter for reflecting the received upstream signal back downstream.

7. The apparatus of claim 1, wherein the apparatus is a part of a tap for use in the network.

8. The apparatus of claim 7, further comprising:
a band stop filter coupled to the first port for filtering out those frequencies of the received upstream signal corresponding to a first frequency band for providing a filtered upstream signal; and
a second port for use in coupling the filtered upstream signal to the network for transmission upstream.

9. The apparatus of claim 1, further comprising:
a network control interface responsive to a control signal for enabling or disabling the reflector.

10. The apparatus of claim 9, wherein the control signal is an out-of-band control signal.

11. A cable modem comprising:
a port for use in coupling to a cable system; and
at least one modem coupled to the port for (a) communicating to a two-way network over a first pair of frequency bands and (b) communicating to at least one other endpoint of the system over a frequency band different from the first pair.

12. A method for use in a device of a system, the method comprising:
coupling to a portion of a network for receiving an upstream signal; and
reflecting the received upstream signal back downstream via the first port.

13. The method of claim 12, wherein the upstream signal has a frequency spectrum including a first frequency band that is different from those frequency bands used by a controller of the network for bi-directional communications.

14. The method of claim 13, wherein the network is a cable network and the controller is a head-end of the cable network.

15. The method of claim 13, wherein the reflecting step includes:
filtering the received upstream signal to provide an output signal for downstream transmission, wherein a frequency spectrum of the output signal includes the first frequency band.

16. The method of claim 15, further comprising:
amplifying the output signal for transmission downstream.

17. The method of claim 12, wherein the reflecting step includes:
using a band stop filter for reflecting the received upstream signal back downstream.

18. The method of claim 12, wherein the device is a part of a tap for use in the network.

19. The method of claim 12, further comprising:
filtering out those frequencies of the received upstream signal corresponding to a first frequency band for providing a filtered upstream signal; and
coupling the filtered upstream signal to the network for transmission upstream.

20. The method of claim 12, further comprising:
receiving a control signal for enabling or disabling the device.

21. The method of claim 20, wherein the control signal is an out-of band control signal.

22. A method for use in a cable modem, the method comprising:
coupling to a cable system;
communicating to a two-way network over a first pair of frequency bands; and
communicating to at least one other endpoint of the cable system over another frequency band different from the first pair.
